(19) United States
(12) Patent Application Publication
(10) Pub. No.: US 2026/0322757 A1
(43) Pub. Date: Oct. 15, 2026

(54) METHODS FOR CONTROLLING A PDCP TRANSMITTER

(71) Applicant: CANON KABUSHIKI KAISHA, Tokyo (JP)

(72) Inventors: Pascal LAGRANGE, LA CHAPELLE DES FOUGERETZ (FR); Pascal ROUSSEAU, RENNES (FR); Yacine EL KOLLI, RENNES (FR); Pierre VISA, RENNES (FR)

(21) Appl. No.: 19/482,115

(22) PCT Filed: May 8, 2024
(86) PCT No.: PCT/EP2024/062824

§ 371 Date: Nov. 6, 2025

(30) Foreign Application Priority Data
May 9, 2023 (EP) 23315178.6
Jul. 11, 2023 (GB) 2310630.5

(51) Int. Cl. H04L 47/28; H04L 47/32

(52) U.S. Cl. CPC H04L 47/28; H04L 47/32

(57) ABSTRACT

A method for operating a packet convergence protocol, PDCP, transmitter, the method comprising: configuring a timer associated with a packet data unit, PDU, which is transmitted to a PDCP receiver based on an importance level of a PDU Set to which the PDU belongs; starting the timer and discarding all PDUs which belong to the PDU Set if a predetermined condition is satisfied when the timer expires; and discarding the PDU alone if the predetermined condition is not satisfied when the timer expires.

### FIELD OF THE INVENTION

The present disclosure generally relates to methods for controlling a packet data convergence protocol (PDCP) transmitter. More particularly, the present disclosure relates to extended reality (XR) in 3GPP 5G NR.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g., video, voice, messaging . . . ) over a radio access network (RAN) through one or more base stations.

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi. Among the requirements for 5G NR, there are service requirements related to extended reality (XR).

XR (extended Reality) applications are defined in 3GPP document RP-2200285 as “various types of augmented, virtual, and mixed environments, where human-to-machine and human-to-human communications are performed with the assistance of handheld and wearable end user devices.” Various use cases can be found in 3GPP document TR-26.928.

Many XR applications involve interactions between a wearable device (for example a 3D helmet or augmented reality glasses) and an application server. The wearable device and the application server can be connected through a local Network (like a wireless LAN) or cellular network (like 3GPP 5G cellular network, the application server being connected to the 5G core network part).

Some XR applications like cloud gaming, involve transferring compressed video data, audio data from the server to the UE and position information from the UE to the server. Some XR applications like virtual reality, involve transferring compressed video data, audio data and various information from the server to the wearable device. Some XR applications like augmented reality, involve transferring compressed video data, audio data and various information exchanged to and from the wearable device and the server.

In the present disclosure, the information exchanged to and from the UE or wearable device and the server is referred to as application data. For example, application data may comprise one or more images, video data, audio data, position information and various information.

The video and audio data are transferred between the wearable device (or the user equipment) and the server using media transport protocols like RTP (Real Time Protocol, RFC 3550), SRTP (Secured RTP, RFC 3711), HTTP (Hyper Text Transfer Protocol, RFC 2616-7540) or QUIC (RFC 8999, 9000, 9001 and 9002). Video encoding and decoding can be performed according to various formats including MPEG2, H.264, H.265, HEVC, etc.

Applications generate data in the form of encoded video, audio or position information. These data are primarily arranged in data packets by the application, an application data packet representing one unit of information is generated at the application level. 3GPP named the set of PDUs (Protocol Data Unit or Packet Data Unit) necessary to transport an application data packet a “PDU Set”. Application data comprises one or more application data packets. In downlink, 3GPP PDUs are formatted by the core network PDU Layer. In the same way, in uplink, the 3GPP PDUs are formatted by the UE (User Equipment) PDU layer. In 3GPP the delimitations of the PDU Sets (start, stop, length) are not provided by the application but generated by the core network (respectively the UE) through media transport protocol packet inspection. The detailed procedure can be found in 3GPP document S2-2302696.

A PDU Set is composed of one or more PDUs carrying the payload of one unit of information generated at the application level (e.g., a frame or video slice for XRM Services, as used in TR 26.926). In some implementations, all PDUs in a PDU Set are needed by the application layer to use the corresponding unit of information. In other implementations, the application layer can still recover parts all or of the information unit, when some PDUs are missing. For example, one PDU Set may comprise the data of one image or frame from a video stream.

The network used to transport the application data can experience perturbation and congestion. It is therefore possible that some PDUs of a PDU Set are missing or are late at the receiving side (UE PDU layer in downlink, Core network UPF in uplink).

Some video decoder implementations require the reception of a complete application data packet (complete PDU Set), received on time, to adequately decode a video. While other implementations can tolerate late arrival of data packets or partial delivery of data packets of a PDU Set. For example, these implementations rely on FEC (Forward Error Correction) technology or concealment techniques.

In 3GPPdocument S2-2302696, a PDU Set QoS parameter called PSDB (PDU Set Delay Budget) defines a time budget allocated to the transport of the PDU Set across the 5G system. This QoS parameter defined by the application is used by a 5G system to assess if a PDU Set (application data packet) is delivered on time.

In the same 3GPP document, S2-2302696, another QoS parameter named PSIHI (PDU Set Integrated Handling Indication) is defined to characterize the decoder tolerance to loss or outdated data. If PSIHI parameter is set to “true”, then the decoder can only handle complete application data packet received on time. If PSIHI is set to “false”, then the decoder can tolerate both incomplete and delayed application data packets.

In the 5G system, at a radio network part, when a PDU Set is being sent over the air interface, some information is available regarding the reception status of the PDUs and the elapsed time of the PDU Set Delay Budget. For example, when a PDU Set is being transferred over the air, a RAN node (Radio Access Network node, either UE or gNB) can detect that one PDU transmission has failed despite all the retransmissions and error correction mechanisms. In that case, if the PSIHI QOS parameter is set to “true”, it means the entire PDU Set is useless to the application. Accordingly, if PDUs of this “useless” PDU Set are pending transmission over the air interface, then the RAN node can consider discarding the remaining transmission of these PDUs thus achieving radio network resource saving.

In aspects of the disclosure, the PSIHI QOS parameter may be configured at a UE device by the network (e.g., by a base station, or gNB). In one example, as long as the PSIHI parameter has not been configured at the UE device, this PSIHI parameter is considered as being set to “false”.

In 3GPP document RP-223502, PDU Set discarding has been set as an objective for the enhancement of the Radio Access Network in order to increase the 5G system capacity to handle XR applications.

Returning now to the PDCP PDU/PDU Set discarding, a PDCP discard timer may be considered to determine whether a PDU Set, and all or part of the PDUs belonging to this PDU Set, should be discarded. Upon expiry of such PDCP discard timer for a given PDU Set, the device in charge of the transmission of the PDCP PDU/PDU Set (i.e., either a UE device or a base station) shall discard the PDU Set.

However, the discarding of a PDU Set may significantly impact the decoding of the associated data stream, such as a video stream, by a decoder at a receiver device level, depending on the PSIHI QOS parameter associated to the considered PDU Set.

Also, when considering PDU Set level packet discarding in the presence of congestion, in order to free radio resources, the impact of such PDU Set discarding on the associated data stream decoding may also differ depending on the PDU Set importance (PSI) within the considered data stream. For instance, the discarding in a video stream of a dependent frame, or P-frame, which decoding is conditioned by the presence at the decoder of the previous frame, may be less critical than the discarding of an independent frame, or I-frame.

Therefore, new mechanisms are required to manage the discarding of a PDU Set, or the discarding of a PDCP PDU belonging to a PDU Set, while limiting the complexity of the processing at the associated transmitter device as well as the latency that may result from such mechanisms.

### SUMMARY

The present disclosure relates to a technique for controlling a packet data convergence protocol (PDCP) in a communication network. In particular, the disclosure is directed towards a means of selectively discarding a packet unit data (PDU) for discarding (or not discarding), amongst a plurality of PDUs for transmission. For example, a PDU may be discarded (or not discarding) based on the level of importance of the PDU.

In accordance with a first aspect the disclosure there is provided a method for managing PDCP packet data unit, PDU, discarding in a communication system comprising a transmitter device and a receiver device, the method at the transmitter device comprising: determining, for one or more of a plurality of PDUs, corresponding importance levels, the importance level corresponding to each PDU being determined based on at least one characteristic of a PDU Set to which the PDU belongs; determining, among the plurality of PDUs, at least one PDU to be discarded based on the determined importance levels (e.g., in dependence on the importance level of the PDU being above/below a threshold value); sending, to the receiver device, at least one PDU of the plurality of PDUs, the at least one sent PDU being determined as not to be discarded.

In accordance with a second aspect of the disclosure there is provided a method for managing PDCP packet data unit, PDU, discarding in a communication system comprising a transmitter device (e.g., a transmitter) and a receiver device (e.g., a receiver), the method at the transmitter device comprising: determining, for one or more of a plurality of PDUs, corresponding relevance levels, the relevance level corresponding to a PDU being determined based on at least one characteristic of a PDU Set to which the PDU belongs; determining, among the plurality of PDUs, at least one PDU to be discarded based on the determined relevance level(s); sending, to the receiver device, one or more PDUs of the plurality of PDUs, the one or more sent PDUs being determined as not to be discarded.

The method at the transmitter may decrease some congestion phenomenon by discarding some PDUs while ensuring that such discarding will have limited impact on the rendering of the data flows associated to the PDUs to be discarded. In this way, the method provides a simple and efficient means of determining the PDU/s which is/are relatively relevant to the PDU set (e.g., most relevant to the PDU Set), and should therefore not be discarded. Consequently, the method reduces the latency (e.g., at the transmitter) due to managing the discarding of PDU(s), whilst reducing the negative impact on the decoding of the data stream. The method may comprise determining a first corresponding relevance level of a first PDU of the plurality of PDUs, and a second corresponding relevance level of the plurality of PDUs of the plurality of PDUs. The method may further comprise determining that the first PDU is to be discarded, based on the first corresponding relevance level, and sending the second PDU to the receiver device having determined (e.g., based on the second corresponding relevance level) that the second PDU is not to be discarded.

Optionally, the method step of determining, among the plurality of PDUs, of at least one PDU to be discarded, based on the determined relevance levels is performed after detecting, by the transmitter device, a triggering event associated with one or more PDUs sent or to be sent by the transmitter device.

Optionally, the triggering event is the expiry of a timer associated with a PDU Set or is the detection of the presence of a specific type of PDU.

Optionally, the duration of the timer associated with the PDU Set is based on at least one of: the level of importance of a PDU which belongs to the PDU Set, the overall number of PDUs in the PDU Set, and the overall PDU Set Delay Budget (PSDB) associated to the PDU Set.

Optionally, the duration of the timer associated with the PDU Set is less than the overall PDU Set Delay Budget (PDSB) associated to the PDU Set.

Optionally, the level of relevance of each of the one or more PDUs is based on at least one of: the probability of success of the transmission of the PDU, the level of importance of the PDU, the ratio of high-importance level PDUs versus low-importance level PDUs in the plurality of PDUs, a discarding tolerance associated to the PDU Set to which the PDU belongs, and a target error rate and/or a PDU Set error rate (PSER) associated with the considered PDUs, or to the PDU set(s) to which the considered PDU(s) belong.

Optionally, the importance level of the PDU may be determined relative to the importance level of at least one PDU of the plurality of the considered PDUs.

Optionally, the probability of success of the transmission of the PDU is based on at least one of: the overall number of PDUs in the PDU Set to which the PDU belongs, the number of not-yet-transmitted PDUs in the PDU Set to which the PDU belongs, the number of already-transmitted PDUs in the PDU Set to which the PDU belongs, the overall packet delay budget associated to the PDU, the remaining time budget left for the transmission of the not-yet-transmitted PDUs in the PDU Set to which the PDU belongs, and a target error rate and/or a PDU Set error rate (PSER) associated with the considered PDUs, or to the PDU set(s) to which the considered PDU(s) belong.

Optionally, the at least one characteristic of a PDU Set to which the PDU belongs includes: a PDU Set importance (PSI); and a PDU Set Integrated Handling Indication (PSIHI).

Optionally, at least two PDUs of the plurality of PDUs belong to a same PDU Set. The at least two PDUs may have two different corresponding relevance levels.

Optionally, the determining of the at least one PDU to be discarded comprises determining a group of PDUs to be discarded based on the relevance level of all or part of the plurality of PDUs.

Optionally, the one or more PDUs belonging to the group of PDUs to be discarded have a low importance level. Optionally the low importance level may be based on the one or more PDUs having a predetermined PSI value range.

Optionally, the determining of the group of PDUs to be discarded is based on at least one of: the probability of success of the transmission of all or part of the low-importance PDUs amongst the plurality of PDUs, the probability of success of the transmission of all or part of the high-importance PDUs amongst the plurality of PDUs, the probability of success of the transmission of a first PDU from the plurality of PDUs, a discarding tolerance associated to the PDU Set to which all or part of the PDUs of the plurality of PDUs belong to, and the ratio of high-importance level PDUs versus low-importance level PDUs in the plurality of PDUs.

Optionally, the PDU(s) belonging to the one or more (e.g., group) of PDU(s) to be discarded belong to different PDU Sets. For example, a first PDU to be discarded may be belong to a first PDU Set and a second PDU to be discarded may belong to a second PDU Set.

Optionally, the PDU(s) belonging to the one or more (e.g., group) of PDU(s) to be discarded include at least one PDU having a high-importance level.

Optionally, the number of determined PDUs to be discarded is determined based on a target number of PDUs to discard. The number of PDUs with the lowest relevance levels among the plurality of PDUs may be discarded.

Optionally, any subsequent PDU belonging to the same PDU Set as the PDU to be discarded is also discarded.

In accordance with a third aspect of the disclosure there is provided a transmitter device configured to perform the above method.

In accordance with a fourth aspect of the present disclosure, there is provided a computer program as recited in claim 18 of the accompanying claims.

In accordance with a fifth aspect of the present disclosure, there is provided a computer-readable medium as recited in claim 19 of the accompanying claims.

Any feature in one aspect of the disclosure may be applied to other aspects of the disclosure, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the disclosure, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the disclosure will now be described, by way of example only, and with reference to the following drawings in which:

FIG. 1 is a schematic diagram illustrating a first example wireless communication system in which the present disclosure may be implemented according to one or more embodiments of the disclosure;

FIG. 2 illustrates a block schematic diagram of an example configuration of a UE in which the present disclosure may be implemented according to one or more embodiments of the disclosure;

FIG. 3 illustrates a block schematic diagram of an example configuration of a base station in which the present disclosure may be implemented according to one or more embodiments of the disclosure;

FIG. 4 is a block schematic diagram illustrating the data plane protocol stack of a 5G NR systems as represented in FIG. 1;

FIG. 5 is a block schematic diagram of an example embodiment of a PDCP protocol layer according to 3GPP document TS 38.323;

FIG. 6 is a flowchart of a method performed by an element of a wireless communication system according to one or more embodiments of the present disclosure;

FIG. 7 is a flowchart of a method performed at a transmitter device according to one or more embodiments of the present disclosure;

FIG. 8 is a flowchart of a method performed at a transmitter device according to one or more embodiments of the present disclosure;

FIG. 9 is a flowchart of a method performed at a transmitter device according to one or more embodiments of the present disclosure;

FIG. 10 is a flowchart of a method performed at a transmitter device according to one or more embodiments of the present disclosure; and

FIG. 11 is a block schematic diagram illustrating example message flows for requesting, by the network, the discarding of one or more PDU sets at a UE device.

### DETAILED DESCRIPTION

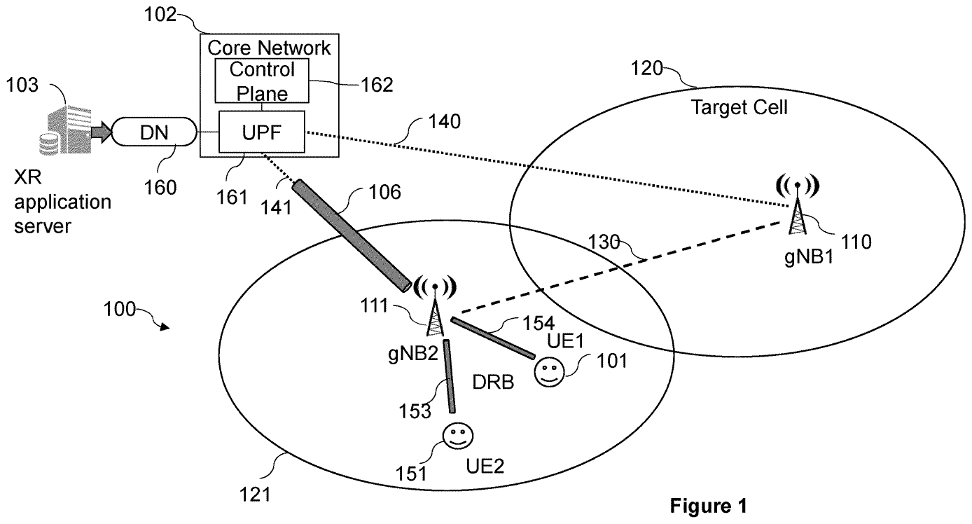

FIG. 1 illustrates an example wireless communication system 100, in particular a mobile radio communication system such as a fifth-generation (5G) New Radio (NR) system supporting extended reality (XR) service. Although in the following description, embodiments, and examples of embodiments of the present disclosure will be described with respect to a 5G NR system, it will be appreciated that it is not intended that the present disclosure is limited to 5G NR systems and may be used in any wireless communication systems supporting XR or a similar service.

The system 100 comprises a User Equipment (UE) 101 (or 151), which may be for instance virtual reality helmets or extended reality wearables like glasses, served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g., smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network 102 by means of the NG interface (specified in the 3GPP document TS 38.413) implemented on the wired or wireless links 140 and 141.

Each of these base stations controls one or multiple cells. For instance, the base station 110 controls the cell 120, and the base station 111 controls the cell 121. A cell is a geographical area of a radio network defined by the frequency used in the cell to transmit data. The cell can be uniquely identified by a UE from an identification that is broadcasted over a geographical area. Each base station 110, 111 can serve several UEs like the UE 101 or UE 151. Once a UE has established a RRC connection with a base station, the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Adaptation Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

It is assumed that the UE 101 is receiving and/or sending XR data of one or more multicast XR sessions generated and/or destinated to the XR application server 103. The XR data are provided to the base station 111, which is the base station controlling the cell 121 on which the UE 101 is attached, through the core network 102 (through the Data Network 160 and the User Plane Function 161) and the transport bearer (also known as GTP-U tunnel) 106 over the link 141. Then, the XR data are transmitted by the base station 111 to the UE 101 through the Data Radio Bearer (DRB) 154. FIG. 1 also shows the UE 151 receiving data through DRB 153. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

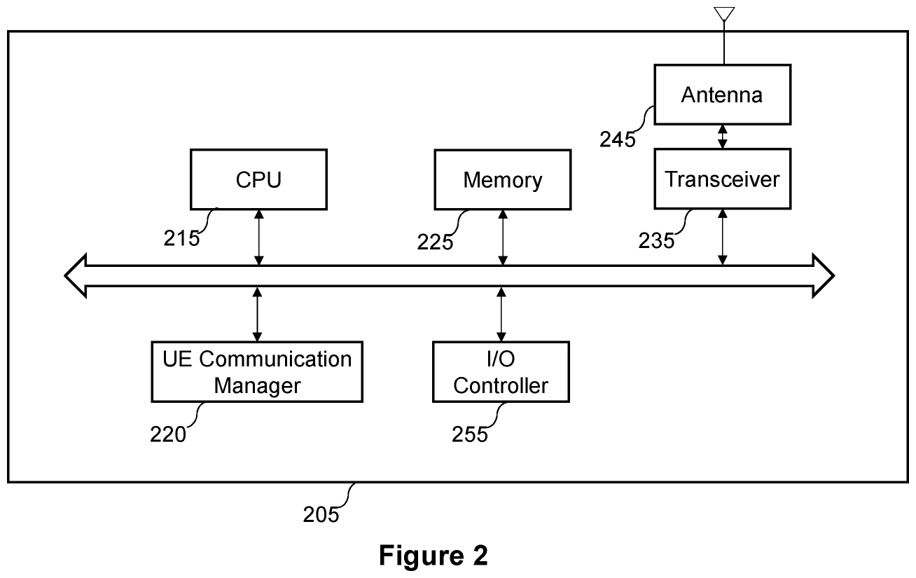

FIG. 2 illustrates a block diagram of a UE device 205, like the UE 101 or UE 151 in FIG. 1, according to an aspect of the present disclosure. The UE includes components for transmitting and receiving communications, for example including at least one of a UE communication manager 220, a I/O controller 255, a transceiver 235, a set of antennas 245, memory 225, and a processor (CPU: Central Processing Unit) 215. All these elements may communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, Windows, Android, etc. The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals. The I/O controller 255 may for example interact with all or part of an image capture device, an image rendering device, an audio capture device, an audio rendering device or a sensor device able to determine the use position.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc. The transceiver 235 may comprise a PDCP transmitter and a PDCP receiver. The PDCP transmitter and the PDCP receiver may be implemented by the processor 215. The PDCP transmitter and the PDCP receiver may be a software only function implemented by the processor 215.

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

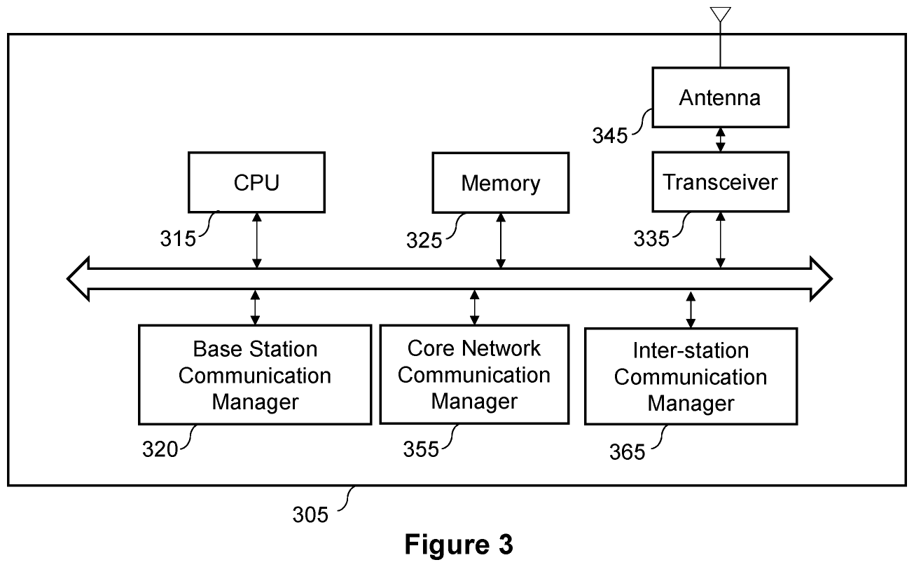

FIG. 3 illustrates a block diagram of a base station device 305, like the base stations or gNBs 110 and 111 in the FIG. 1, in which the present disclosure may be implemented according to one or more embodiments of the disclosure. The base station device 305 includes components for transmitting and receiving communications. For example, the base station includes at least one of a Base Station communication manager 320, a Core Network communication manager 355, a transceiver 335, a set of antennas 345, memory 325, a processor (CPU) 315, and an Inter-Station communication manager 365. All these elements may communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 may include a PDCP transmitter and a PDCP receiver. The PDCP transmitter and the PDCP receiver may be implemented by the processor 315. The PDCP transmitter and the PDCP receiver may be a software only function implemented by the processor 315. The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

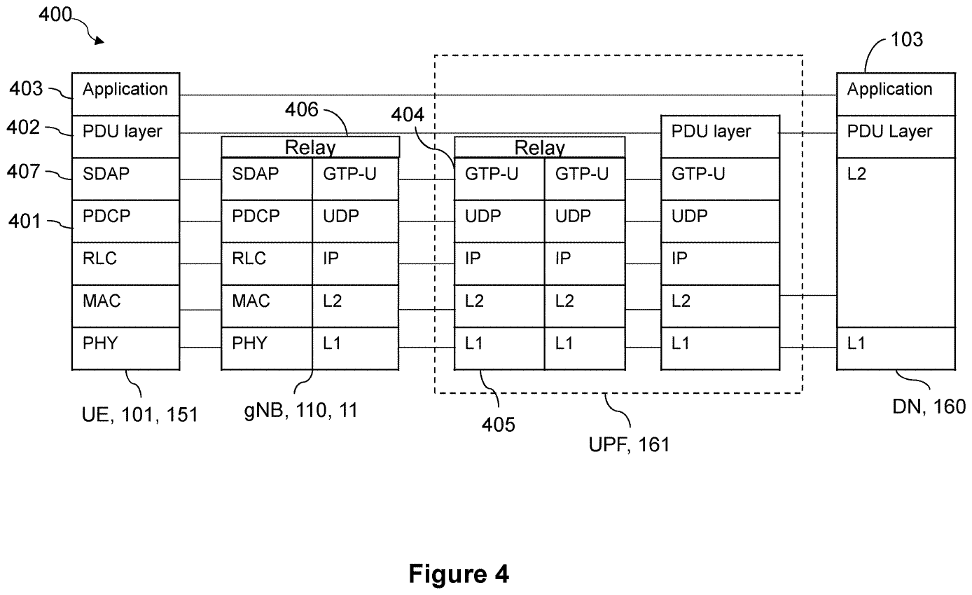

FIG. 4 is a block schematic diagram illustrating the data plane protocol stack of a 5G NR systems as represented in FIG. 1. This data plane protocol stack is described in detail in 3GPP document TS 23.501. In the downlink direction, an application server 103 connects to the UPF (User Plane Function) 161 through a data network 160 at PDU layer 402 level. PDU layer corresponds to the PDUs carried between the UE (User Equipment) and the DN (Data Network) over the PDU Session. When the PDU Session Type is IPv4 or IPv6 or IPv4v6, it corresponds to IPv4 packets or IPv6 packets or both of them; When the PDU Session Type is Ethernet, it corresponds to Ethernet frames; etc. At PDU session establishment time, the core network provides session QoS parameters to UPF, gNB and UE. The PDU session QoS parameters include the XR PDU Set QoS parameters (S2-2302696):
1. PDU Set Delay Budget (PSDB);
2. PDU Set Error Rate (PSER); and
3. PDU Set Integrated Handling Indication (PSIHI). Formerly called PDU Set Integrated Indication.

In the description of FIG. 4, unless stated otherwise, a PDU refers to the packets handled by the PDU layer 402, all other layers handle other types of PDUs and their PDUs will be prefixed by the layer name, e.g. PDCP PDU. When the PDUs arrive at the UPF PDU layer 402, the UPF performs application packets inspection to determine the PDU Set boundaries. Document S2-2302696 provides examples on how to identify PDU Sets when inspecting RTP/SRTP header, RTP header extension, H.264 RTP payload, H.265 RTP payload and H.266 RTP payload.
PDU Set identification information as described in S2-2303842 are determined by UPF and sent to the NG-RAN in the GTP-U header. The PDU Set identification Information comprises at least one of the following:
PDU Set Sequence Number;
Indication of End PDU of the PDU Set;
PDU Sequence Number within a PDU Set;

PDU Set Size in bytes; and
PDU Set Importance, which identifies the relative importance of a PDU Set compared to other PDU Sets within a QoS Flow.

In uplink the application is located on the UE. As explained earlier, the UE obtains the PDU session QoS parameter from the core network when the PDU session is established (PDU session establishment procedure is defined in TS 23.502 clause 4.3.2.). When the PDUs generated by the application 403 arrive at UE PDU layer 402, the UE performs an application packets inspection to determine the PDU Set boundaries in the same way as described earlier for UPF.

In both downlink and uplink, the application 103 sends and receives data to/from the NG-RAN through a GPRs tunnel (GTP-U layer 404, TS 29.281).

In downlink, the UPF detects the PDU Set identification information and obtains from the core network a set of mapping rules (e.g., filtering rules). The filtering rules define how each PDU Set is mapped to QOS flows. QoS Flows are identified by an identifier, and GTP-U PDUs are marked according to the determined QOS flow identifier. At the gNB, the relay layer 406 extracts PDU Set identification information and QoS flow identifier from GTP-U PDUs and maps them into SDAP QOS flows. In one XR session, multiple PDU Sets can be mapped to the same QoS flow. Alternatively (or in addition), one or more PDU Sets may be mapped to different QoS flows. Then according to 3GPP document TR-38.835, in one alternative, each SDAP QOS flow can be mapped to a different PDCP DRB (Data Radio Bearer). According to a second alternative, all SDAP QOS flows from the same XR session are mapped to a single PDCP DRB.

In uplink, the UE detects the PDU Set identification information at PDU layer 402, and obtains from the core network a set of mapping rules (e.g., filtering rules). The filtering rules define how each PDU Set is mapped to QoS flows. The UE maps the XR PDUs to associated SDAP QOS flows according to the filtering rules. In the same way as for downlink, in uplink, in one XR session, multiple PDU Sets can be mapped to the same QoS flow and, in one XR session, some PDU Sets may be mapped to different QoS flows.

In downlink, the application layer 103, generates application flows toward one UE, for example one or more video flows and one or more audio flows. Then at PDU layer 402, the application flows are arranged in PDU Sets. Each application flow is divided into multiple PDU Sets of the same or different types. Then in GTP-U layer 404, each PDU Set type is mapped on QoS flows, so multiple application flows can be multiplexed in one QoS flow, or each application flows can be mapped to different QoS, it is also possible that an application flow is divided into multiple QOS flows. Then the SDAP layer 407 maps the QoS flows into DRBs (Data Radio Bearers) each DRB being handled by a dedicated PDCP entity. As with the QoS flows, multiple application flows can be multiplexed in one DRB, or each application flow can be mapped to a different DRB. It is also possible that an application flow is divided into multiple DRBs.

In uplink, the application layer 403, generates application flows toward the application server 103, for example one or more video flows, one or more audio flows, one or more sensing flows. Then at PDU layer 402, the application flows are arranged in PDU Sets. Each application flow is divided in multiple PDU Sets of same or different types and each PDU Set type is mapped on QOS flows, so multiple application flows can be multiplexed in one QoS flow, or each application flow can be mapped to different QoS. It is also possible that an application flow is divided into multiple QoS flows. Then the SDAP layer 407 maps the QoS flows into DRBs (Data Radio Bearer) each radio bearer being handled by a dedicated PDCP entity. Same as for QoS flows, multiple application flows can be multiplexed in one DRB, or each application flow can be mapped to DRBs, it is also possible that an application flow is divided into multiple DRBs.

In downlink the PDU Set identification information calculated by the core network UPF (User Plane Function) are inserted in the GTP-U (GPRS Tunnelling Protocol-User Plane, TS 29.281) header. GTP-U is the protocol used by the UPF to transport data from the core network to the gNB. When GTP-U PDUs arrives at gNB SDAP (Service Data Adaptation layer, TS 37.324), the GTP-U header is removed and the PDU Set identification information is no more provided in-band. Hence the UE side (receiving side) in downlink does not have access to the PDU Set identification information.

In uplink the PDU Set identification information calculated by the UE PDU layer are not inserted in any header, so the PDU Set identification information are not provided in-band. Hence the gNB side (receiving side) in uplink does not have access to the PDU Set identification information. To summarize, at all protocol layers (including the PDCP layer), the receiving entity does not have knowledge of the PDU Sets identification information, not in downlink nor in uplink.

On the transmit side (both uplink and downlink), all layers below SDAP layer (e.g., PDCP transmitting entity) do not have access to in-band PDU Set identification information, but internal mechanisms like PDU context information are used to associate out-band PDU Set delimitation information to each PDU. For example, in the gNB, the GTP-U receiving entity can associate out-band PDU Set delimitation information to each PDU, and pass them to PDCP transmitting entity. Another example is in the UE, the PDU layer can associate out-band PDU Set delimitation information to each PDU and pass them to the PDCP transmitting entity.

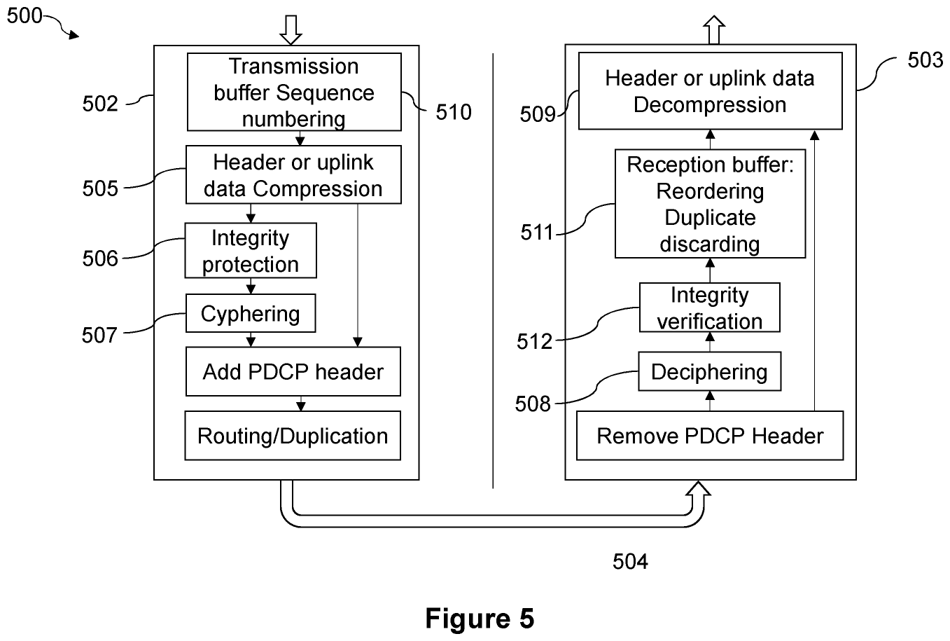

FIG. 5 is a block schematic diagram of an example embodiment of a PDCP protocol layer (e.g., such as the PDCP layer 401 as shown in FIG. 4) of a communication system 500 according to 3GPP document TS 38.323. The PDCP layer is composed of a PDCP transmitting entity 502 and a PDCP receiving entity 503. In this figure, the two PDCP entities do not belong to the same NG-RAN node. The two PDCP entities are connected by radio communication 504 which represents a simplified view on all lower layers from RLC to PHY. For example, PDCP transmitting entity 502 is located on UE 101 and PDCP receiving entity 503 is located on gNB 111. However, the present disclosure is not limited to this particular example, the PDCP transmitting entity (PDCP transmitter) 502 may be located on the gNB 111 and the PDCP receiving entity (PDCP receiver) 503 may be located on UE 101.

Each NG-RAN node implements both PDCP transmitting and receiving entities, they are not all represented in this figure for simplicity.

Each functional block of the PDCP entities is described in detail in 3GPP document TS 38.323. Each PDCP entity is carrying the data of one radio bearer. A PDCP entity is associated either to the control plane or the user plane depending on which radio bearer it is carrying data for. A PDCP entity associated with DRB/MRB can be configured by RRC layer (TS 38.331, control plane not shown in FIG. 4) to use header compression or uplink data compression (UDC) 505. Robust header compression protocol (ROHC), the Ethernet header compression protocol (EHC) and UDC are supported. Each header compression protocol is independently configured for a DRB/MRB. The compression 505 is performed by the transmitting entity 502, and the decompression 509 is performed by the receiving entity 503.

The integrity protection function includes both integrity protection 506 and integrity verification 512 and is performed in PDCP, if configured by RRC. The data unit that is integrity protected is the PDCP PDU header and the data part of the PDCP PDU before ciphering. The integrity protection is always applied to PDCP Data PDUs of SRBs (Signalling Radio Bearer). The integrity protection is not applicable to PDCP Control PDUs.

The ciphering function includes both ciphering 507 and deciphering 508 and is performed in PDCP, if configured. The data unit that is ciphered is the MAC-I (1203, 1213, 1223) and the data part of the PDCP Data PDU except the SDAP header and the SDAP Control PDU if included in the PDCP SDU (Service Data Unit). The ciphering is not applicable to PDCP Control PDUs.

If configured, PDCP transmitting entity 502 performs buffer sequence numbering 510, while PDCP receiving entity 503 performs re-ordering and duplication discarding 511.

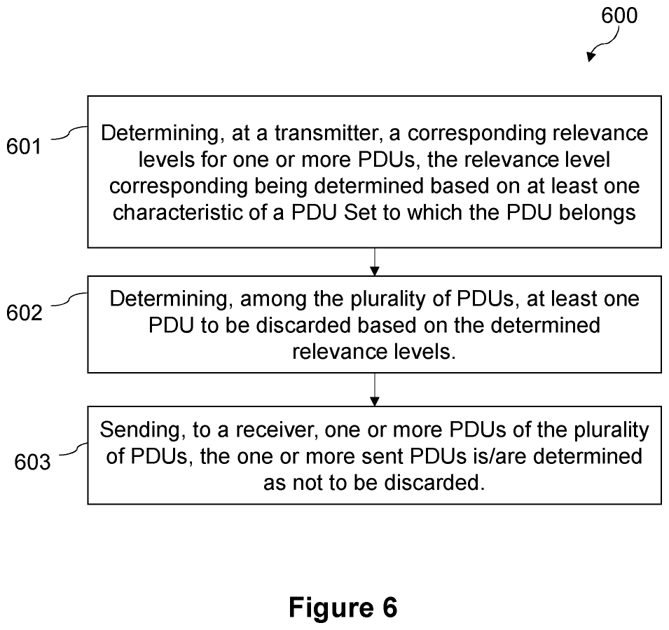

A method for managing PDCP packet data unit, PDU, discarding will now be described with reference to FIG. 6. The method may be performed by one or more elements of a communication system as described above. For example, the communication system 500 may include a transmitting entity 502 (e.g., a transmitter) connected to a receiving entity 503 (e.g., receiver), as shown in FIG. 5.

The method at the transmitter device starts with the method step 601, which involves determining, for one or more of a plurality of PDUs, corresponding relevance levels. The relevance level corresponding to a PDU is determined based on at least one characteristic of a PDU Set to which the PDU belongs.

The method proceeds with method step 602, which involves determining, among the plurality of PDUs, at least one PDU to be discarded based on the determined relevance levels.

Subsequently, the method continues with the method step 603 by sending, to the receiver device, one or more PDUs of the plurality of PDUs. The one or more sent PDUs is/are determined as not to be discarded by the system.

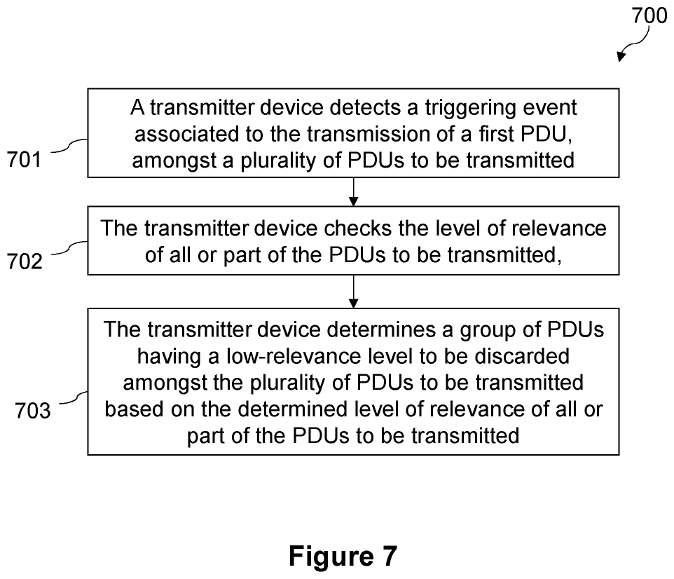

FIG. 7 is a flow chart illustrating an example method executed by a transmitter device for managing PDU discarding according to one or more embodiments of the disclosure.

For example, with reference to the wireless communication system shown in and described with respect to FIG. 1, the transmitter device performing the method 700 of FIG. 7 may be a base station, such as base station 111, or a UE device, such as UE device 101 or 102.

The method 700 as shown in and described with respect to FIG. 7, may be performed by software elements and/or hardware elements.

In case the transmitter device performing the method 700 is a base station, this transmitter device may be implemented in a communication device 305 as shown in and described with reference to FIG. 3 with the method as shown in and described with respect to FIG. 6 being performed by one or more processing units, such as the Base Station Communication Manager unit 320.

In case the transmitter device performing the method 700 is a UE device, this transmitter device may be implemented in a communication device 205 as shown in and described with reference to FIG. 2 with the method as shown in and described with respect to FIG. 7 being performed by one or more processing units, such as the UE Communication Manager unit 220.

In a first step 701, a transmitter device detects a triggering event associated to the transmission of a first PDU, amongst a plurality of PDUs to be transmitted.

In one example, the plurality of PDUs to be transmitted may belong to different PDU Sets and may have different levels of importance or PDU Set Importance (PSI), as discussed in FIG. 4.

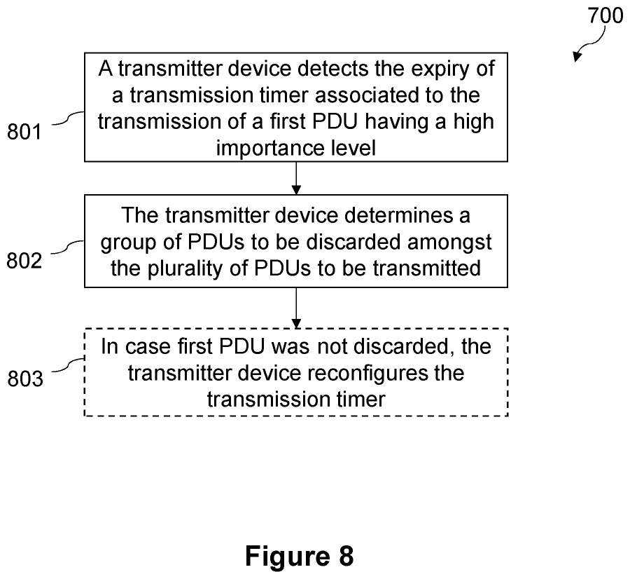

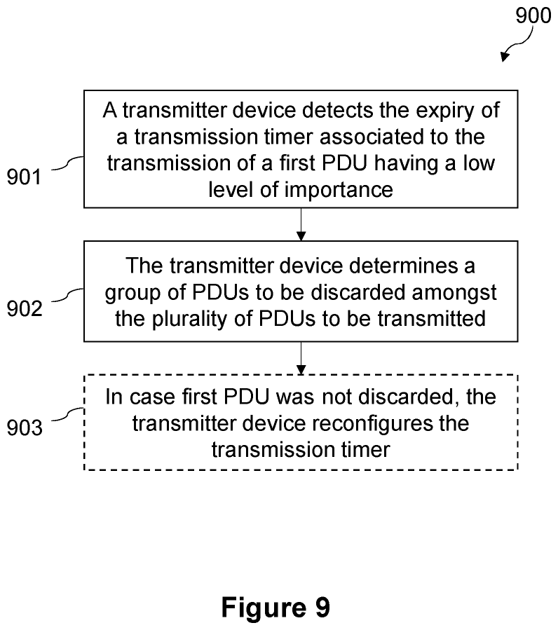

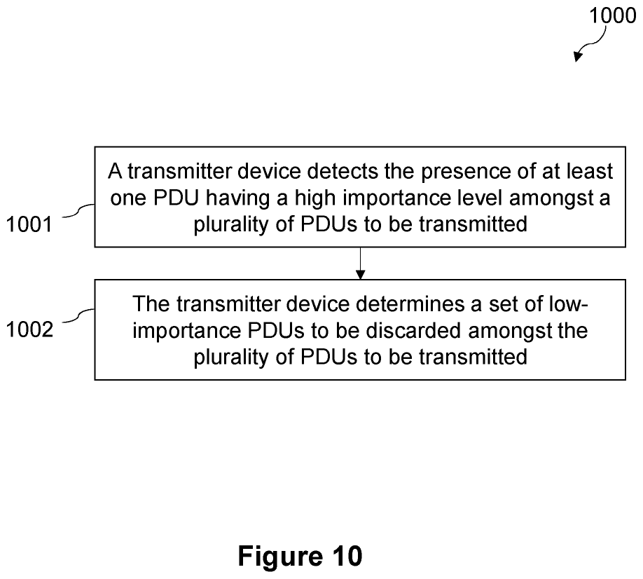

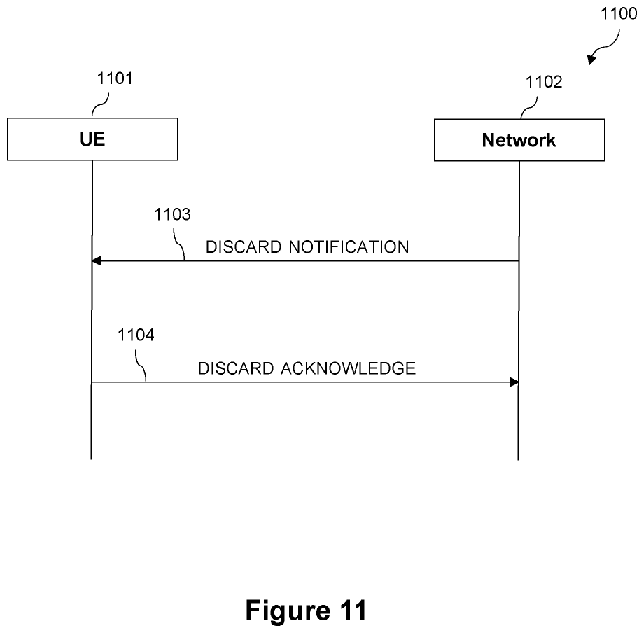

According to one aspect of the disclosure, the triggering event detected by the transmitter device may be any one of:
a transmission timer, or transmissionTimer, expiry (some aspects of the disclosure associated to the use of a transmission timer, or transmissionTimer, expiry as a triggering event are shown in FIG. 8 and FIG. 9); and
the presence of a PDU having a high level of importance amongst the plurality of PDUs to be transmitted (some aspects of the disclosure associated to the use of the presence of a PDU having a high level of importance amongst the plurality of PDUs to be transmitted as a triggering event are shown in FIG. 10); and
the reception of a DISCARD NOTIFICATION message 1003 from the network, as shown in FIG. 11.

In one aspect of the disclosure, the considered transmission timer may be associated to the transmission of either a PDU associated to a PDU Set having a high level of importance, i.e., PDU set having a high PDU Set Importance (PSI) value, or a PDU set having a low level of importance, i.e., a PDU set having a low PDU Set Importance (PSI) value.

In one example, the PDU Set Importance (PSI) is a binary information, where a PSI value of “1” means the PDU Set has a high importance, while a PSI value of “0” means the PDU Set has a low importance.

In one example, the PDU Set Importance (PSI) is a non-binary information, i.e., the PSI value may be set to more than two different values. In such case, the higher the PSI value, the higher the importance of the associated PDU Set.

In the following description, the importance of a PDU, or PDU importance (e.g., level of importance of a PDU), is equal to the importance of the PDU Set, or PDU Set Importance (PSI), to which the PDU belongs.

In one example, the transmission timer, or transmissionTimer, discussed in FIG. 7 and subsequent FIGS. 8 to 10, is the PDCP layer discardTimer, as defined in 3GPP TS 38.323. In another example, the transmission timer, or transmission Timer, discussed in FIG. 7 and subsequent FIGS. 8 to 10, is a timer managed at PDCP layer and is different from the PDCP layer discardTimer defined in 3GPP TS 38.323.

In one aspect of the disclosure, the duration of the transmission Timer is less than the overall PDU Set Delay Budget (PSDB) associated to the PDU Set to which the PDU belongs.

In one aspect of the disclosure, when the transmitter device is a UE device, the duration of the transmissionTimer is configured by the serving base station, for example via an RRC configuration message such as, for instance, the RRCReconfiguration or the RRCSetup message, as defined in TS 38.331.

In a second step 702, the transmitter device may check the level of relevance of all or part of the PDUs amongst the plurality of PDUs to be transmitted, where the level of relevance of a given PDU is a function of a characteristic of the PDUs, for example including all or part of the following:
the probability of success of the transmission of the given PDU;
the level of importance of the given PDU;
the ratio of high-importance level PDUs versus low-importance level PDUs in the plurality of PDUs to be transmitted;
a discarding tolerance associated to the PDU Set to which the given PDU belongs; and
a target error rate and/or a PDU Set error rate (PSER) associated to the considered PDUs, or to the PDU set(s) to which the considered PDU(s) belong. In one example, the target error rate and/or the PDU Set error rate (PSER) is considered for PDU relevance estimation only when the consideration of the above parameters does not allow differentiation between the relevance values of a plurality of PDUs belonging to a plurality of PDU sets.

In FIG. 7 and subsequent FIGS. 8 to 10, according to one example, the discarding tolerance may be reflected by PSIHI QoS parameter.

In FIG. 7 and subsequent FIGS. 8 to 10, the plurality of PDUs to be transmitted may include all or part of the following:
SDAP PDUs delivered to the PDCP transmitting entity and stored as PDCP SDUs in the buffer 510; and
PDCP PDUs delivered to lower layer for which the successful delivery is not confirmed.

In one aspect of the disclosure, the probability of success of the transmission of a given PDU is a function of any one of the following or any combination thereof:
the overall number of PDUs in the PDU Set to which the given PDU belongs;
the number of remaining, i.e., not-yet-transmitted, PDUs in the PDU Set to which the given PDU belongs;
the number of sent, i.e., already-transmitted, PDUs in the PDU Set to which the given PDU belongs;
the overall packet delay budget associated to the given PDU. In one example, the overall packet delay budget of a PDU is the PDU Set Delay Budget (PSDB) associated to the PDU Set the PDU belongs to. In another example, depending on the PSIHI (PDU Set Integrated Handling Indication) the overall packet delay budget is the PDU Delay Budget (PDB) associated to the PDU;
the remaining time budget left for the transmission of the not-yet-transmitted PDUs in the PDU Set to which the given PDU belongs; and
a target error rate and/or a PDU Set error rate (PSER) associated to the considered PDUs or to the PDU set(s) to which the considered PDU(s) belong.

In FIG. 7 and subsequent FIGS. 8 to 10, the overall number of PDUs may refer to an average value or a maximum value or a minimum value or a value between a minimum and a maximum value or an estimated value.

In FIG. 7 and subsequent FIGS. 8 to 10, in one example, the number of sent, i.e., already-transmitted, PDUs may refer to all or part of the following:
PDUs sent to lower layers for which a delivery confirmation was received; and
PDUs sent to lower layers with unknown or missed delivery status.

In one example, the probability of success of the transmission of a given PDU increases when the ratio of the sent PDUs versus the remaining PDUs in the PDU Set the given PDU belongs to, or versus the overall number of PDUs in the PDU Set the given PDU belongs to, increases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one example, the probability of success of the transmission of a given PDU increases when the ratio of the remaining PDUs versus the sent PDUs in the PDU Set the given PDU belongs to, or versus the overall number of PDUs in the PDU Set the given PDU belongs to, decreases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

Then, in step 703, the transmitter device determines a group of PDUs having a low-relevance level to be discarded amongst the plurality of PDUs to be transmitted based on the level of relevance of all or part of the PDUs to be transmitted determined at step 702.

In one aspect of the disclosure, the PDUs belonging to the group of low-relevance level PDUs to be discarded is chosen amongst the PDUs having low importance level (for example, PDUs having a PSI value of “0”).

By doing so, the transmitter device may decrease some congestion phenomenon by discarding some PDUs while ensuring that such discarding will have limited impact on the rendering of the data flows associated to the PDUs to be discarded.

In one aspect of the disclosure, the size of the group of PDUs having a low-relevance level to be discarded is based on a target number of PDUs to discard, or targetPDUToDiscard, information.

In one example, in case the transmitter device is a UE device, the targetPDUToDiscard information is configured at the UE device by its serving base station, for example via an RRC configuration message such as, for instance, the RRCReconfiguration or the RRCSetup message, as defined in TS 38.331 or a PDCP control PDU as defined in TS 38.323.

In one example, in case the transmitter device is a UE device, upon the determining by the UE of the size of the group of PDUs having a low-relevance to be discarding, sending by the UE a PDU discard notification to the gNB indicating at least the size of the group of PDU having low-relevance to be discarded, or PDUToDiscardSize, as determined by the remote UE.

In one example, the PDU discard notification is an RRC configuration message such as, for instance, the RRCReconfiguration or the RRCSetup message, as defined in TS 38.331 or a PDCP control PDU as defined in TS 38.323.

In one example, targetPDUToDiscard and PDUToDiscardSize have the same value. In one example, targetPDUToDiscard and PDUToDiscardSize have different values.

In one aspect of the disclosure, any subsequent PDU belonging to the same PDU Set as a low-relevance level PDU to be discarded may also be discarded. In one example, a PDU Set for which all the subsequent PDUs will be discarded has a PSIHI QOS parameter set to “true”, i.e., a PDU Set for which a decoder cannot tolerate both incomplete or delayed application data packets, as discussed in FIG. 4.

By doing so, the transmitter device may decrease some congestion phenomenon by discarding some PDUs while optimizing the network bandwidth usage by not transmitting PDU that will no longer be needed by the decoder of a receiver device in charge of decoding the data flows sent by the transmitter device.

In one aspect of the disclosure, a low-relevance level PDU to be discarded belongs to a PDU Set for which a PSIHI parameter is set to “false”, i.e., a PDU Set for which a decoder can tolerate both incomplete and delayed application data packets, as discussed in FIG. 4.

In one other aspect of the disclosure, the group of low-relevance level PDUs to be discarded may include PDUs having high importance level. In one example, such chosen PDUs may belong to a PDU Set for which a PSIHI parameter is set to “false”, i.e., a PDU Set for which a decoder can tolerate both incomplete and delayed application data packets, as discussed in FIG. 4.

By giving precedence for discarding to some PDUs having a PSIHI parameter set to “false”, regardless of their actual importance, the transmitter device may decrease some congestion phenomenon by discarding some PDUs while ensuring that such discarding will have limited impact on the rendering of the data flows associated to the PDUs to be discarded.

Some aspects of the disclosure related to the estimation a PDU relevance and the associated determination of a group of PDUs to be discarded amongst a plurality of PDUs to be transmitted is further discussed in relation to FIGS. 8 to 10.

FIG. 8 is a flow chart illustrating an example method executed by a transmitting device for managing PDU discarding according to one or more embodiments of the disclosure.

For example, with reference to the wireless communication system shown in and described with respect to FIG. 1, the transmitter device performing the method 800 of FIG. 8 may be a base station, such as base station 111, or a UE device, such as UE device 101 or 102.

The method 800 as shown in and described with respect to FIG. 8, may be performed by software elements and/or hardware elements.

In case the transmitter device performing the method 800 is a base station, this transmitter device may be implemented in a communication device 305 as shown in and described with reference to FIG. 3 with the method as shown in and described with respect to FIG. 8 being performed by one or more processing units, such as the Base Station Communication Manager unit 320.

In case the transmitter device performing the method 800 is a UE device, this transmitter device may be implemented in a communication device 205 as shown in and described with reference to FIG. 2 with the method as shown in and described with respect to FIG. 8 being performed by one or more processing units, such as the UE Communication Manager unit 220.

In a first step 801, a transmitter device detects the expiry of a transmission timer, or transmission Timer, associated to the transmission of a first PDU having a high importance level, as discussed in relation with FIG. 7, amongst a plurality of PDUs to be transmitted.

In one aspect of the disclosure, the duration of the transmission Timer is less than the overall PDU Set Delay Budget (PSDB) associated to the PDU Set the PDU belongs to.

In one aspect of the disclosure, the duration of the transmission Timer is a function of any one of the following or any combination thereof:
the level of importance of the PDU. In one example, the higher the level of importance of a PDU, the greater is the duration of the transmission Timer,
the overall number of PDUs in the PDU Set the first PDU belongs to. In one example, the higher the number of PDUs in the PDU Set the first PDU belongs to, the greater is the duration of the transmission Timer,
the overall PDU Set Delay Budget (PSDB) associated to the PDU Set to which the considered PDU belongs.

In one aspect of the disclosure, the duration of the transmission Timer is less than the overall PDU Set Delay Budget (PSDB) associated to the PDU Set the considered PDU belongs to. In one example, the duration of the transmission Timer is set to a predefined ratio of the overall PDU Set Delay Budget (PSDB) associated to the PDU Set to which the considered PDU belongs.

In one aspect of the disclosure, in step 801, instead of detecting the expiry of a transmission timer, the transmitter device may detect the reception of a DISCARD NOTIFICATION message 1003 from the network, as shown in FIG. 11.

In another aspect of the disclosure, a transmitter device may perform the detection of the expiry of a transmission timer only if it has previously received a DISCARD NOTIFICATION message 1003 from the network, as shown in FIG. 11.

In a second step 802, the transmitter device determines a group of PDUs to be discarded amongst the plurality of PDUs to be transmitted based on any one of the following or any combination thereof:
the probability of success of the transmission of all or part of the low-importance PDUs amongst the plurality of PDUs to be transmitted;
the probability of success of the transmission of all or part of the high-importance PDUs amongst the plurality of PDUs to be transmitted;
the probability of success of the transmission of the first PDU;
a discarding tolerance associated to the PDU Set to which all or part of the PDUs to be transmitted belong;
the ratio of high-importance level PDUs versus low-importance level PDUs in the plurality of PDUs to be transmitted; and
a target error rate and/or a PDU Set error rate (PSER) associated to the considered PDUs or to the PDU set(s) to which the considered PDU(s) belong.

In FIG. 8 and subsequent FIGS. 9 and 10, in one aspect of the disclosure, the size of the group of PDUs to be discarded amongst the plurality of PDUs to be transmitted is based on a target number of PDUs to discard, or targetPDUToDiscard, information.

In one example, in case the transmitter device is a UE device, the targetPDUToDiscard information is configured at the UE device by its serving base station, for example via an RRC configuration message such as, for instance, the RRCReconfiguration or the RRCSetup message, as defined in TS 38.331.

In one aspect of the disclosure, the probability of success of the transmission of a given PDU is a function of any one of the following or any combination thereof:
the number of remaining, i.e., not-yet-transmitted, PDUs in the PDU Set to which the given PDU belongs;
the number of sent, i.e., already-transmitted, PDUs in the PDU Set to which the given PDU belongs;
the overall packet delay budget associated to the given PDU. In one example, the overall packet delay budget of a PDU is the PDU Set Delay Budget (PSDB) associated to the PDU Set to which the PDU belongs; and
the remaining time budget left for the transmission of the not-yet-transmitted PDUs in the PDU Set to which the given PDU belongs; and
a target error rate and/or a PDU Set error rate (PSER) associated to the considered PDUs or to the PDU set(s) to which the considered PDU(s) belong.

In one example, the probability of success of the transmission of a given PDU increases when the ratio of the sent PDUs versus the remaining PDUs in the PDU Set the given PDU belongs to, or versus the overall number of PDUs in the PDU Set the given PDU belongs to, increases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one example, the probability of success of the transmission of a given PDU increases when the ratio of the remaining PDUs versus the sent PDUs in the PDU Set the given PDU belongs to, or versus the overall number of PDUs in the PDU Set the given PDU belongs to, decreases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one aspect of the disclosure, the determining by the transmitter device of a group of PDUs to be discarded amongst the plurality of PDUs to be transmitted is performed if the probability of success of the transmission of the first PDU considered in step 801 is below a predefined threshold at the time the transmission Timer expires.

In one aspect of the disclosure, if the probability of success of the transmission of the first PDU considered in step 801 is above a predefined threshold, the transmitter device may not discard any PDU. In one aspect of the disclosure, the PDUs belonging to the group of PDUs to be discarded is chosen amongst the PDUs having a low importance level.

By doing so, the transmitter device may decrease some congestion phenomenon by discarding some PDUs while ensuring that such discarding will have limited impact on the rendering of the data flows associated to the PDUs to be discarded.

In one aspect of the disclosure, any subsequent PDU belonging to the same PDU Set as a PDU to be discarded may also be discarded.

By doing so, the transmitter device may decrease some congestion phenomenon by discarding some PDUs while optimizing the network bandwidth usage by not transmitting PDU that will no longer be needed by the decoder of a receiver device in charge of decoding the data flows sent by the transmitter device.

In one aspect of the disclosure, PDUs belonging to the group of PDUs to be discarded may belong to different PDU Sets.

In one aspect of the disclosure, a PDU to be discarded belongs to a PDU Set for which a PSIHI parameter is set to “false”, i.e., a PDU Set for which a decoder can tolerate both incomplete and delayed application data packets, as discussed in FIG. 4.

In one aspect of the disclosure, the transmitter device may discard a PDU having its PSIHI parameter set to “false” if the probability of success of the transmission of the said PDU is below a predefined threshold. In another example, the transmitter device may discard the PDU with the lowest probability of success of its transmission amongst the PDUs having their PSIHI parameter set to “false”.

In one other aspect of the disclosure, the group of PDUs to be discarded may include PDUs having high importance level.

In one example, such high-importance level PDUs may belong to a PDU Set for which a PSIHI parameter is set to “false”, i.e., a PDU Set for which a decoder can tolerate both incomplete and delayed application data packets, as discussed in FIG. 4.

In one example, the discarding of a PDU having a high-importance level may depend on the PSIHI parameter setting of the PDU Sets for the other PDUs belonging to the group of PDUs to be transmitted.

In one example, in case all the low-importance PDUs to be transmitted belong to PDU Sets having their PSIHI parameter set to “true” while the first PDU belongs to a PDU Set having its PSIHI parameter set to “false”, the transmitter device may discard the first PDU. In one example, the transmitter device may discard the first PDU having its PSIHI parameter set to “false” if the probability of success of the transmission of the first PDU is below a predefined threshold.

In one example, in case all the low-importance PDUs to be transmitted belong to PDU Sets having their PSIHI parameter set to “true” while the first PDU belongs to a PDU Set having its PSIHI parameter set to “true” as well, the transmitter device may discard a high-importance level PDU belonging to a PDU Set having its PSIHI parameter set to “false”. In one example, the transmitter device may discard a high-importance level PDU having its PSIHI parameter set to “false” in case the probability of success of the transmission of the high-importance level PDU is below a predefined threshold. In another example, the transmitter device may discard the PDU with the lowest probability of success of its transmission amongst the high-importance level PDUs having their PSIHI parameter set to “false”.

By giving precedence for discarding to some PDUs having a PSIHI parameter set to “false”, regardless of their actual importance, the transmitter device may decrease some congestion phenomenon by discarding some PDUs while ensuring that such discarding will have limited impact on the rendering of the data flows associated to the PDUs to be discarded.

In one aspect of the disclosure, any subsequent PDU belonging to the same PDU Set as a high-importance level PDU to be discarded may also be discarded.

In another aspect of the disclosure, in case the ratio of high-importance level PDUs versus low-importance level PDUs in the plurality of PDUs to be transmitted is above a predefined threshold (i.e., the high-importance level PDUs significantly outnumber the low-importance level PDUs), the transmitter device may preferably discard some high-importance level PDUs. In such case, in one example, the transmitter device may preferably discard the high-importance PDUs belonging to PDU sets having their PSIHI parameter set to “false” and/or having a low probability of transmission success.

In another aspect of the disclosure, in case the ratio of high-importance level PDUs versus low-importance level PDUs in the plurality of PDUs to be transmitted is below a predefined threshold (i.e., the low-importance level PDUs significantly outnumber the high-importance level PDUs), the transmitter device may preferably discard some low-importance level PDUs.

In such case, in one example, the transmitter device may preferably discard the low-importance PDUs belonging to PDU sets having their PSIHI parameter set to “false” and/or having a low probability of transmission success.

In case the first PDU considered in step 801 was not discarded in step 802, the transmitter device may reconfigure the transmission timer associated to the first PDU in step 803. In one example, the value to which the transmission timer is reinitiated corresponds to the remaining time from the overall packet delay budget associated to the PDU Set the first PDU belongs to, i.e., the time left for the transmission of the not-yet-transmitted PDUs in the PDU Set the first PDU belongs to before the overall packet delay budget is consumed.

FIG. 9 is a flow chart illustrating an example method executed by a transmitting device for managing PDU discarding according to one or more embodiments of the disclosure.

For example, with reference to the wireless communication system shown in and described with respect to FIG. 1, the transmitter device performing the method 900 of FIG. 9 may be a base station, such as base station 111, or a UE device, such as UE device 101 or 102.

The method 800 as shown in and described with respect to FIG. 9, may be performed by software elements and/or hardware elements.

In case the transmitter device performing the method 900 is a base station, this transmitter device may be implemented in a communication device 305 as shown in and described with reference to FIG. 3 with the method as shown in and described with respect to FIG. 9 being performed by one or more processing units, such as the Base Station Communication Manager unit 320.

In case the transmitter device performing the method 900 is a UE device, this transmitter device may be implemented in a communication device 205 as shown in and described with reference to FIG. 2 with the method as shown in and described with respect to FIG. 9 being performed by one or more processing units, such as the UE Communication Manager unit 220.

In a first step 901, a transmitter device detects the expiry of a transmission timer, or transmission Timer, associated to the transmission of a first PDU having a low importance level, as discussed in relation with FIG. 7, amongst a plurality of PDUs to be transmitted.

In one aspect of the disclosure, the duration of the transmission Timer is less than the overall PDU Set Delay Budget (PSDB) associated to the PDU Set the PDU belongs to.

In one aspect of the disclosure, the duration of the transmission Timer is a function of any one of the following or any combination thereof: the level of importance of the PDU. In one example, the higher the level of importance of a PDU, the greater is the duration of the transmission Timer, the overall number of PDUs in the PDU Set the first PDU belongs to. In one example, the higher the number of PDUs in the PDU Set the first PDU belongs to, the greater is the duration of the transmission Timer, the overall PDU Set Delay Budget (PSDB) associated to the PDU Set the considered PDU belongs to; and In one aspect of the disclosure, the duration of the transmission Timer is less than the overall PDU Set Delay Budget (PSDB) associated to the PDU Set to which the considered PDU belongs.

In one example, the duration of the transmission Timer is set to a predefined ratio of the overall PDU Set Delay Budget (PSDB) associated to the PDU Set to which the considered PDU belongs.

In one aspect of the disclosure, in step 901, instead of detecting the expiry of a transmission timer, the transmitter device may detect the reception of a DISCARD NOTIFICATION message 1003 from the network, as shown in FIG. 11.

In another aspect of the disclosure, a transmitter device may perform the detection of the expiry of a transmission timer only if it has previously received a DISCARD NOTIFICATION message 1003 from the network, as shown in FIG. 11.

In a second step 802, the transmitter device determines a group of PDUs to be discarded amongst the plurality of PDUs to be transmitted based on any one of the following or any combination thereof:
the presence of PDUs having a high level of importance amongst the plurality of PDUs to be transmitted;
the ratio of high-importance level PDUs versus low-importance level PDUs in the plurality of PDUs to be transmitted;
the probability of success of the transmission of all or part of the PDUs to be transmitted, including the first PDU, amongst the plurality of PDUs to be transmitted;
a discarding tolerance associated to the PDU Set to which all or part of the PDUs to be transmitted belong; and
a target error rate and/or a PDU Set error rate (PSER) associated to the considered PDUs or to the PDU set(s) to which the considered PDU(s) belong.

In one aspect of the disclosure, the probability of success of the transmission of a given PDU a function of any one of the following or any combination thereof:
the number of remaining, i.e., not-yet-transmitted, PDUs in the PDU Set to which the given PDU belongs;
the number of sent, i.e., already-transmitted, PDUs in the PDU Set to which the given PDU belongs;
the overall packet delay budget associated to the given PDU. In one example, the overall packet delay budget of a PDU is the PDU Set Delay Budget (PSDB) associated to the PDU Set the PDU belongs to;
the remaining time budget left for the transmission of the not-yet-transmitted PDUs in the PDU Set to which the given PDU belongs; and
a target error rate and/or a PDU Set error rate (PSER) associated to the considered PDUs or to the PDU set(s) to which the considered PDU(s) belong.

In one example, the probability of success of the transmission of a given PDU increases when the ratio of the sent PDUs versus the remaining PDUs in the PDU Set the given PDU belongs to, or versus the overall number of PDUs in the PDU Set the given PDU belongs to, increases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one example, the probability of success of the transmission of a given PDU increases when the ratio of the remaining PDUs versus the sent PDUs in the PDU Set the given PDU belongs to, or versus the overall number of PDUs in the PDU Set the given PDU belongs to, decreases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one aspect of the disclosure, the PDUs belonging to the group of PDUs to be discarded is chosen amongst the PDUs having a low importance level. In one example, the transmitter device may preferably discard the first PDU.

In one aspect of the disclosure, PDUs belonging to the group of PDUs to be discarded may belong to different PDU Sets.

In one aspect of the disclosure, the determining by the transmitter device of a group of PDUs to be discarded amongst the plurality of PDUs to be transmitted is performed if the probability of success of the transmission of the first PDU considered in step 901 is below a predefined threshold at the time the transmission Timer expires.

In one aspect of the disclosure, if the probability of success of the transmission of the first PDU considered in step 901 is above a predefined threshold, or if the first PDU belongs to a PDU Set for which a PSIHI parameter is set to “true”, i.e., a PDU Set for which a decoder cannot tolerate either incomplete or delayed application data packets (as discussed in FIG. 4), the transmitter device may not discard the first PDU. In such a case, in one example, the transmitter device may discard a low-importance level PDU (if any) different from the first PDU. In such a case, the transmitter device may preferably discard a low-importance level PDU belonging to a PDU Set for which a PSIHI parameter is set to “false”, i.e., a PDU Set for which a decoder can tolerate both incomplete and delayed application data packets.

In one aspect of the disclosure, any subsequent PDU belonging to the same PDU Set as a PDU to be discarded may also be discarded.

By doing so, the transmitter device may decrease some congestion phenomenon by discarding some PDUs while optimizing the network bandwidth usage by not transmitting PDU that will no longer be needed by the decoder of a receiver device in charge of decoding the data flows sent by the transmitter device.

In one aspect of the disclosure, the transmitter device may add to the group of PDUs to be discarded one or more high-importance level PDUs. In one example, in case the first PDU belongs to a PDU Set for which a PSIHI parameter is set to “true” (i.e., the PDU Set for which a decoder cannot tolerate either incomplete or delayed application data packets), the transmitter device may add to the group of PDUs to be discarded some high-importance level PDUs belonging to PDU Sets for which a PSIHI parameter is set to “false”, i.e., PDU Sets for which a decoder can tolerate both incomplete and delayed application data packets.

In another aspect of the disclosure, in case the ratio of high-importance level PDUs versus low-importance level PDUs in the plurality of PDUs to be transmitted is above a predefined threshold (i.e., the high-importance level PDUs significantly outnumber the low-importance level PDUs), the transmitter device may discard some high-importance level PDUs in addition to low-importance level PDUs. In such case, in one example, the transmitter device may preferably discard the high-importance PDUs belonging to PDU sets having their PSIHI parameter set to “false” and/or having a low probability of transmission success.

In another aspect of the disclosure, in case the ratio of high-importance level PDUs versus low-importance level PDUs in the plurality of PDUs to be transmitted is below a predefined threshold (i.e., the low-importance level PDUs significantly outnumber the high-importance level PDUs), the transmitter device may preferably discard some low-importance level PDUs (including the first PDU). In such case, in one example, the transmitter device may preferably discard the low-importance PDUs belonging to PDU sets having their PSIHI parameter set to “false” and/or having a low probability of transmission success.

In case the first PDU considered in step 901 was not discarded in step 902, the transmitter device may reconfigure the transmission timer associated to the first PDU in step 903. In one example, the value to which the transmission timer is reinitiated corresponds to the remaining time from the overall packet delay budget associated to the PDU Set the first PDU belongs to, i.e., the time left for the transmission of the not-yet-transmitted PDUs in the PDU Set the first PDU belongs to before the overall packet delay budget is consumed.

FIG. 10 is a flow chart illustrating an example method executed by a transmitting device for managing PDU discarding according to an embodiment of the disclosure.

For example, with reference to the wireless communication system shown in and described with respect to FIG. 1, the transmitter device performing the method 1000 of FIG. 10 may be a base station, such as base station 111, or a UE device, such as UE device 101 or 102.

The method 1000 as shown in and described with respect to FIG. 10, may be performed by software elements and/or hardware elements.

In case the transmitter device performing the method 1000 is a base station, this transmitter device may be implemented in a communication device 305 as shown in and described with reference to FIG. 3 with the method as shown in and described with respect to FIG. 10 being performed by one or more processing units, such as the Base Station Communication Manager unit 320.

In case the transmitter device performing the method 1000 is a UE device, this transmitter device may be implemented in a communication device 205 as shown in and described with reference to FIG. 2 with the method as shown in and described with respect to FIG. 10 being performed by one or more processing units, such as the UE Communication Manager unit 220.

In a first step 1001, a transmitter device detects the presence of some PDU(s) having a high importance level amongst a plurality of PDUs to be transmitted.

In one aspect of the disclosure, detecting the presence of some PDU(s) having a high importance level amongst a plurality of PDUs to be transmitted includes (e.g., consists of) detecting the presence of at least one high-importance level PDUs amongst the plurality of PDUs to be transmitted.

In one aspect of the disclosure, detecting the presence of some PDU(s) having a high importance level amongst a plurality of PDUs to be transmitted consists in detecting that the ratio of high-importance level PDUs versus low-importance level PDUs in the plurality of PDUs to be transmitted is above a predefined threshold (i.e., the number of high-importance level PDUs is greater than the number of low-importance level PDUs with a predefined margin).

In one aspect of the disclosure, detecting the presence of some PDU(s) having a high importance level amongst a plurality of PDUs to be transmitted consists in detecting that the number of high-importance level PDUs in the plurality of PDUs to be transmitted is above a predefined threshold.

In one aspect of the disclosure, in step 1001, instead of detecting the presence of some PDU(s) having a high importance level amongst a plurality of PDUs to be transmitted, the transmitter device may detect the reception of a DISCARD NOTIFICATION message 1103 from the network, as shown in FIG. 11.

In another aspect of the disclosure, a transmitter device may perform the detection of the presence of some PDU(s) having a high importance level amongst a plurality of PDUs to be transmitted only if it has previously received a DISCARD NOTIFICATION message 1103 from the network, as shown in FIG. 11.

In a step 1002, the transmitter device determines a group of PDUs to be discarded amongst the plurality of PDUs to be transmitted based on any one of the following or any combination thereof:
the probability of success of the transmission of all or part of the PDUs to be transmitted, including the first PDU, amongst the plurality of PDUs to be transmitted;
a discarding tolerance associated to the PDU Set to which all or part of the PDUs to be transmitted belong to; and
the ratio of high-importance level PDUs versus low-importance level PDUs in the plurality of PDUs to be transmitted.

In one aspect of the disclosure, the probability of success of the transmission of a given PDU is a function of any one of the following or any combination thereof:
the number of remaining, i.e., not-yet-transmitted, PDUs in the PDU Set the given PDU belongs to;
the number of sent, i.e., already-transmitted, PDUs in the PDU Set the given PDU belongs to;
the overall packet delay budget associated to the given PDU. In one example, the overall packet delay budget of a PDU is the PDU Set Delay Budget (PSDB) associated to the PDU Set the PDU belongs to;
the remaining time budget left for the transmission of the not-yet-transmitted PDUs in the PDU Set to which the given PDU belongs; and
a target error rate and/or a PDU Set error rate (PSER) associated to the considered PDUs or to the PDU set(s) to which the considered PDU(s) belong.

In one example, the probability of success of the transmission of a given PDU increases when the ratio of the sent PDUs versus the remaining PDUs in the PDU Set the given PDU belongs to, or versus the overall number of PDUs in the PDU Set the given PDU belongs to, increases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one example, the probability of success of the transmission of a given PDU increases when the ratio of the remaining PDUs versus the sent PDUs in the PDU Set the given PDU belongs to, or versus the overall number of PDUs in the PDU Set the given PDU belongs to, decreases. In one example, the aforementioned probability may be increased, resp. decreased, if the remaining time budget left for the transmission of the not-yet-transmitted PDUs in the PDU Set the given PDU belongs to is above, resp. below, a predefined threshold or if the packet delay budget of a PDU is above, resp. below, a predefined threshold.

In one aspect of the disclosure, the determining by the transmitter device of a group of PDUs to be discarded amongst the plurality of PDUs to be transmitted is performed if the probability of success of the transmission of the first PDU considered in step 1001 is below a predefined threshold.

In one aspect of the disclosure, if the probability of success of the transmission of the first PDU considered in step 1001 is above a predefined threshold, the transmitter device may not discard any PDU.

In one aspect of the disclosure, the PDUs belonging to the group of PDUs to be discarded is chosen amongst the PDUs having a low importance level. By doing so, the transmitter device may decrease some congestion phenomenon by discarding some PDUs while ensuring that such discarding will have limited impact on the rendering of the data flows associated to the PDUs to be discarded.

In one aspect of the disclosure, any subsequent PDU belonging to the same PDU Set as a PDU to be discarded may also be discarded. By doing so, the transmitter device may decrease some congestion phenomenon by discarding some PDUs while optimizing the network bandwidth usage by not transmitting PDU that will no longer be needed by the decoder of a receiver device in charge of decoding the data flows sent by the transmitter device.

In one aspect of the disclosure, the PDUs belonging to the group of PDUs to be discarded may belong to different PDU Sets.

In one aspect of the disclosure, a PDU to be discarded belongs to a PDU Set for which a PSIHI parameter is set to “false”, i.e., a PDU Set for which a decoder can tolerate both incomplete and delayed application data packets, as discussed in FIG. 4.

In one aspect of the disclosure, the transmitter device may discard a PDU having its PSIHI parameter set to “false” if the probability of success of the transmission of the said PDU is below a predefined threshold. In another example, the transmitter device may discard the PDU with the lowest probability of success of its transmission amongst the PDUs having their PSIHI parameter set to “false”.

In another aspect of the disclosure, the group of PDUs to be discarded may include PDUs having high importance level.

In one example, such high-importance level PDUs may belong to a PDU Set for which a PSIHI parameter is set to “false”, i.e., a PDU Set for which a decoder can tolerate both incomplete and delayed application data packets, as discussed in FIG. 4.

In one aspect of the disclosure, the discarding of a PDU having a high-importance level may depend on the PSIHI parameter setting of the PDU Sets for the other PDUs belonging to the group of PDUs to be transmitted.

In one example, in case all or part of the low-importance PDUs to be transmitted belong to PDU Sets having their PSIHI parameter set to “true” while all or part of the high-importance level PDU which presence has been detected in step 901 belong to a PDU Set for which a PSIHI parameter is set to “false”, the transmitter device may add all or part of the high-importance level PDU which presence has been detected in step 901 to the group of PDUs to be discarded. In one example, the transmitter device may discard a high-importance level PDU having its PSIHI parameter set to “false” if the probability of success of the transmission of this PDU is below a predefined threshold.

By giving precedence for discarding to some PDUs having a PSIHI parameter set to “false”, regardless of their actual importance, the transmitter device may decrease some congestion phenomenon by discarding some PDUs while ensuring that such discarding will have limited impact on the rendering of the data flows associated to the PDUs to be discarded.

In one aspect of the disclosure, any subsequent PDU belonging to the same PDU Set as a high-importance level PDU to be discarded may also be discarded.

Referring now also to FIG. 11 which is a block schematic diagram illustrating example message flows for requesting by the network the discarding of one or more PDU sets at a UE device.

According to an example, a base station (which may correspond to base station 111 of FIG. 1 described above) may request some PDU set discarding to a served transmitter device (which may correspond to UE 101 of FIG. 1) by sending a PDU set discarding request through a DISCARD NOTIFICATION message 1103.

In one aspect of the invention, the DISCARD NOTIFICATION message 1103 may include a target number of PDUs/PDU sets to discard, or targetPDUToDiscard, information, which is also discussed in relation to FIGS. 7 to 10.

In one example, the target number of PDUs to discard value (or targetPDUToDiscard information) relates to a single PDU set to be discarded by the transmitter device, which means that the base station may issue one DISCARD NOTIFICATION message 1103 relating to a single PDU set.

In another example, the target number of PDUs to discard value (or targetPDUToDiscard information) relates to a plurality of PDU sets to be discarded by the UE, which means that the base station may issue one DISCARD NOTIFICATION message 1103 relating to a plurality of PDU sets.

In one example, in case the DISCARD NOTIFICATION message 1103 includes a target number of PDU sets to discard, the target number of PDU sets to discard, or targetPDUToDiscard, information is set to one.

### In One Example, in Case the Discard Notification Message 1103 Includes a Target

number of PDU sets to discard, the target number of PDU sets to discard, or targetPDUToDiscard, information is set to an integer number of PDU sets strictly greater than one.

In one aspect of the invention, upon reception of a DISCARD NOTIFICATION message 1003, the transmitter device 1101 may apply the method defined in any one of FIGS. 7 to 10 to perform the discarding of the requested one or more PDU Sets or the discarding of the requested plurality of PDUs associated to one or more PDU sets.

In one example the DISCARD NOTIFICATION message 1103 may not include any information on the target number of PDUs/PDU sets to discard (or targetPDUToDiscard information). In such case, the transmitter device 1001 may apply the method defined in any one of FIGS. 7 to 10 to perform the discarding of a single PDU Set.

In another aspect, the DISCARD NOTIFICATION message 1103 may include a “target number of PDUs to discard value” set to an infinite value. Alternatively, the DISCARD NOTIFICATION message 1103 may not include any information on the target number of PDUs/PDU sets to discard, or targetPDUToDiscard information. Further alternatively, the DISCARD NOTIFICATION message 1103 may include information for requesting the start of PDU Set/PDU discarding by the transmitter device.

In such case, upon reception of a DISCARD NOTIFICATION message 1103, the transmitter device 1101 may apply the method defined in any one of FIG. 7 to 10 to perform the discarding of PDU Sets or the discarding of a plurality of PDUs corresponding to a plurality of PDU sets. The method may proceed until it receives a notification from the base station 1102 to stop performing PDU Set/PDU discarding.

In one example, the notification from the base station 1002 to stop performing PDU Set/PDU discarding is performed through the sending by the base station of new DISCARD NOTIFICATION message 1103, which indicates that the discarding operation of the transmitter device should be stopped.

In one example, the notification from the base station 1102 to stop performing PDU Set/PDU discarding is performed through the sending by the base station of a DISCARD INTERRUPTION message 1105, which indicates that the discarding operation of the transmitter device should be stopped.

In one example, once the discarding operation at the transmitter device 1101 is complete, the transmitter device 1101 may send a DISCARD INFORMATION message 1104 to the base station 1102 to confirm that the discarding operation (i.e., which was requested previously through the DISCARD NOTIFICATION message 1103) is complete.

At least one, or each, of the DISCARD NOTIFICATION 1103, DISCARD INTERRUPTION 1105, and DISCARD INFORMATION 1104 messages may be the RRCReconfiguration message defined in 3GPP TS 38.331.

The present disclosure may also cover the following description:

### 1. Triggering of XR Discard Mechanism

In RAN2 #122, it was agreed that the network indicates the UE to apply PSI-based XR discard mechanism via dedicated signalling. In this respect, upon reception of such an indication, the UE may perform PSI-based XR discard based on further considerations, e.g., delay budget, PSIHI. Therefore, the network indication to the UE to apply PSI-based XR discard mechanism may be considered as a request to activate/deactivate PSI-based XR discard mechanism at UE level. Therefore, it may be proposed that RAN2 confirms that the network authorizes the UE to perform PSI-based XR discarding by sending a notification to the UE. In terms of signalling, some optimization may be considered in order to limit the frequency of the network discard notifications to UE. For instance, the PSI-based XR discard notification issued by the network may not be limited to a single-PDU Set discarding but may be related to a specific amount of PDU Sets to be discarded. One may also consider some kind of ON/OFF mechanism where the reception of a PSI-based XR discard notification at the UE would initiate a PDU Set discarding process which would further be stopped upon reception of a subsequent notification from the network. Therefore, it may be proposed that the network may request the UE to perform PSI-based XR discarding for a limited amount of packets/PDU Set. It may also be proposed that the network may notify the UE to start or stop performing PSI-based XR discarding.

### 2. Discard Policy

Once authorized by the network to perform PDU Set discarding, a UE may consider some additional criteria along with the PSI to discriminate the PDU Sets that are to be actually discarded. In this respect, in order to discriminate the one or more PDU Sets to be discarded amongst several PDU Sets having the same PSI, the UE may consider the remaining time budget for each of these PDU Sets and further estimate the transmission success likelihood for these PDU Sets. Therefore, some early timer, different from the existing PSDB discard timer, may be considered for PDU Set discarding, where the current value of this early timer would be considered with regards to the remaining amount of data to be transmitted for the considered PDU Set. Such early timer may be used in addition to the PSI of a given PDU Set. The expiry time of this early timer may even be a function of the PSI. Therefore, it may be proposed that when performing PSI-based XR discarding, the UE may rely on an early timer, different from the PSDB discard timer, which value would be used to identify the PDU Set(s) to be discarded. It may also be proposed that the value of the early timer used for performing PSI-based XR discarding may be a function of the PSI.

In RAN2 #122, it was also agreed that some PDU-set discard indication for UL is configured using RRC to handle the PDU Set based discard functionality (i.e., whether UE discards all packets in PDU set when one PDU is discarded). This configuration is per PDCP entity. In other words, along with the PSI, a UE may also consider the PSIHI associated to a PDU Set to determine whether this PDU Set should be discarded or not. Therefore, it may be proposed that when performing PSI-based XR discarding, the UE may also rely on the PSIHI indication which has been configured for a PDU Set.

While the present disclosure has been described with reference to examples and embodiments, it is to be understood that the disclosure is not limited to the disclosed examples and embodiments. It will be appreciated by those skilled in the art that various changes and modification might be made without departing from the scope of the disclosure, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments (i.e., exemplary arrangements), the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fibre optic cable, twisted pair, digital subscriber line (DSL), or wireless technologies such as infrared, radio, and microwave, then the coaxial cable, fibre optic cable, twisted pair, DSL, or wireless technologies such as infrared, radio, and microwave may be included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for operating a packet convergence protocol, PDCP, transmitter, the method comprising:
configuring a timer associated with a packet data unit, PDU, which is transmitted to a PDCP receiver based on an importance level of a PDU Set to which the PDU belongs;
starting the timer;
discarding all PDUs which belong to the PDU Set if a predetermined condition is satisfied when the timer expires; and
discarding the PDU alone if the predetermined condition is not satisfied when the timer expires.

2. (canceled)

3. The method of claim 1, wherein starting of the timer comprises:
the detection of the presence of a specific type of PDU.

4. The method of claim 1, wherein the duration of the timer associated with the PDU Set is based on at least one of:
the overall number of PDUs in the PDU Set, and
the overall PDU Set Delay Budget (PSDB) associated to the PDU Set.

5. The method of claim 4, wherein the duration of the timer associated with the PDU Set is less than the overall PDU Set Delay Budget (PDSB) associated to the PDU Set.

6. The method of claim 1, wherein the importance level of the PDU Set to which the PDU belongs is based on:
a probability of success of transmission of the PDU.

7. The method of claim 6, wherein the probability of success of the transmission of the PDU is based on at least one of:
an overall number of PDUs in the PDU Set to which the PDU belongs,
a number of not-yet-transmitted PDUs in the PDU Set to which the PDU belongs,
a number of already-transmitted PDUs in the PDU Set to which the PDU belongs,
an overall packet delay budget associated to the PDU,
a remaining time budget left for transmission of the not-yet-transmitted PDUs in the PDU Set to which the PDU belongs, and
a target error rate and/or a PDU Set error rate (PSER) associated with the considered PDUs, or to the PDU set(s) to which the considered PDU(s) belong.

8. The method of claim 1, wherein the predetermined condition indicates that the PDCP receiver cannot tolerate incomplete and delayed application data packets, wherein the predetermined condition includes:
a PDU Set Integrated Handling Indication, PSIHI.

9-14. (canceled)

15. The method of claim 1, wherein the number of PDUs to be discarded is determined based on a target number of PDUs to discard, and wherein the number of PDUs with the lowest importance levels are discarded.

16. (canceled)

17. A PDCP transmitter configured to perform the method of claim 1.

18. A non-transitory computer readable medium carrying instructions which, when executed by a transmitter device, cause the transmitter device to carry out the method of:
configuring a timer associated with a packet data unit, PDU, which is transmitted to a PDCP receiver based on an importance level of a PDU Set to which the PDU belongs;
starting the timer;
discarding all PDUs which belong to the PDU Set if a predetermined condition is satisfied when the timer expires; and
discarding the PDU alone if the predetermined condition is not satisfied when the timer expires.

19. (canceled)

20. The method of claim 8, wherein the PSIHI is configured by the network.
